(19) United States
(12) Patent Application Publication
(10) Pub. No.: US 2018/0246321 A1
(43) Pub. Date: Aug. 30, 2018

(54) ADDITIVE MANUFACTURING APPARATUS AND AN OPTICAL MODULE FOR USE IN AN ADDITIVE MANUFACTURING APPARATUS

(71) Applicant: RENISHAW PLC, Wotton-under-Edge, Gloucestershire (GB)

(72) Inventors: Paul CAMPTON, Repton (GB); Ceri BROWN, Redland (GB)

(73) Assignee: RENISHAW PLC, Wotton-under-Edge, Gloucestershire (GB)

(21) Appl. No.: 15/755,233

(22) PCT Filed: Sep. 21, 2016
(86) PCT No.: PCT/GB2016/052934

§ 371 Date: Feb. 26, 2018

(30) Foreign Application Priority Data
Sep. 21, 2015 (GB) 1516681.2

(51) Int. Cl. G02B 26/10; G02B 26/08; B29C 64/268; B29C 64/153; B33Y 30/00; B23K 26/06

(52) U.S. Cl. CPC G02B 26/101; G02B 26/0875; G02B 26/0816; B29C 64/268; B33Y 10/00; B33Y 30/00; B23K 26/0643; B23K 26/0648; B29C 64/153

(57) ABSTRACT

This invention concerns an additive manufacturing apparatus for building an object by consolidating material in a layer-by-layer manner using an energy beam. The additive manufacturing apparatus comprising an optical module for steering a laser beam onto the material and for collecting light generated by an interaction of the laser beam with the material. The optical module comprises a beam splitter angled relative to an optical path shared by the laser beam and the collected light. The beam splitter separates the collected light from a path of the laser beam for directing the collected light to a detector. The optical module further comprises a corrective optical element for correcting for at least one optical aberration introduced into the collected light by the beam splitter.

### FIELD OF INVENTION

This invention concerns an additive manufacturing apparatus and an optical module for use in an additive manufacturing apparatus. The invention has particular, but not exclusive, application to a laser solidification apparatus in which material is solidified with a laser beam on a layer-by-layer basis to form an object.

### BACKGROUND

WO2015/040433 discloses an optical module for use in additive manufacturing apparatus, the optical module arranged to direct and focus a laser beam for solidifying material of a powder bed, to collect light emitted from a plasma plume and/or a melt pool generated by the laser beam and direct the collected light onto a detector.

The optical module is an “on-axis” optical system, wherein the collected light is directed to the detector along a path of the laser beam, the collected light being reflected from the mirrors of the steering optics and passing through the optics for focussing the laser beam. A beam splitter angled relative to the beam path is used to separate the collected light from the path of the laser beam. The beam splitter has a suitable coating such that light of a laser wavelength is reflected from the beam splitter whereas collected light of other wavelengths passes through the beam splitter to the detector. As the collected light passes through the focussing optics, the beam of collected light is converging when incident on the beam splitter leading to variable transmission path with incident angle. Thus the beam of collected light suffers aberrations, some, such as spherical aberrations, arising from the focussing optics, and others, such as astigmatism and the coma limit, arising from the beam splitter.

The collected light contains a broadband of wavelengths, from the visible spectrum (300-700 nm) emitted by the plasma plume to the near or far infrared (700 nm-3 μm) emitted by the hot melt pool. It will be understood that the term “collected light” as used herein includes these wavelengths.

### SUMMARY OF INVENTION

According to a first aspect of the invention there is provided an additive manufacturing apparatus for building an object by consolidating material in a layer-by-layer manner using an energy beam, the additive manufacturing apparatus comprising an optical module for steering a laser beam onto the material and for collecting light generated by an interaction of the laser beam with the material, the optical module comprising a beam splitter angled relative to an optical path shared by the laser beam and the collected light, the beam splitter separating the collected light from a path of the laser beam for directing the collected light to a detector, the optical module comprising a corrective optical element for correcting for at least one optical aberration introduced into the collected light by the beam splitter.

In this way, an image of the collected light directed to the detector is, at least partially, free from the at least one optical aberration.

In one embodiment, the laser beam may be the energy beam used to consolidate the material. In another embodiment, the laser beam may be a separate beam from the energy beam. For example, the laser beam may be a low powered laser beam (relative to the higher powered energy beam) for monitoring the consolidation process and the energy beam may be a high power laser or electron beam steered by a steering module separate from the optical module.

The corrective optical element may be an optical element separate from the beam splitter disposed in a path of the collected light downstream of the beam splitter.

For example, a separate lens, such as described in U.S. Pat. No. 4,412,723.

Alternatively, beam splitter may be arranged for reflecting the laser wavelength and transmitting wavelengths of the collected light other than the laser wavelength, the corrective optical element formed as an optical feature in a rear surface of the beam splitter so as to modify light transmitted through the beam splitter. The corrective optical element may have been formed on the rear surface of the beam splitter by laser ablation and, optionally, laser melting of the rear surface. The beam splitter may comprise a silica substrate, a rear surface of which is ablated using a laser to form the corrective optical element.

By integrating the corrective optical element into the beam splitter, the corrective optical element does not need to be aligned in a separate step to alignment of the beam splitter, the optical module is more compact and the solution is potentially cheaper than providing a separate corrective optical element.

The corrective optical element may form a refractive optical element that bends light transmitted through the beam splitter differentially across a plane of the beam splitter to compensate for the aberrations.

Alternatively, the corrective optical element may be a diffractive optical element.

The corrective optical element may provide beam shaping in addition to correction of the aberrations. The corrective optical element may spatially offset different wavelengths of the collected light and/or shape the beam of collected light to effectively couple into one or more detectors.

The optical module may comprise focussing optics for focusing the laser beam on to the material. The focussing optics may maintain the laser beam focussed on a working plane as the laser beam is directed to different areas of the material bed. The focussing optics may comprise movable lenses for dynamically adjusting the focus of the laser beam. Alternatively, the focussing optics may comprise an fe-lens. The collected light may be focussed into a non-collimated beam by the focussing optics before impinging on the beam splitter. The corrective optical element may correct for aberrations arising as a result of the non-collimated beam of collected light impinging on the beam splitter.

The optical module may comprise rotatable mirrors for steering the laser beam onto the material.

According to a second aspect of the invention there is provided an optical module for steering a laser beam onto the material in an additive manufacturing apparatus, in which an object is built by consolidating material in a layer-by-layer manner using an energy beam, the optical module comprising an aperture from which the laser beam is delivered to the material and through which light generated by an interaction of the laser beam with the material is collected, a beam splitter angled relative to an optical path shared by the laser beam and the collected light, the beam splitter separating the collected light from a path of the laser beam for directing the collected light to a detector, and a corrective optical element for correcting for at least one optical aberration introduced into the collected light by the beam splitter.

The aperture may comprise a window of material transparent to the laser beam and the collected light.

The optical module may comprise an output for the delivering the collected light to a detector.

According to a third aspect of the invention there is provided an additive manufacturing apparatus for building an object by consolidating material in a layer-by-layer manner using an energy beam, the additive manufacturing apparatus comprising an optical module for steering a laser beam onto the material and for collecting light generated by an interaction of the laser beam with the material, the optical module comprising a beam splitter angled relative to an optical path shared by the laser beam and the collected light, the beam splitter arranged to reflect the laser beam and transmit the collected light, wherein a rear surface of the beam splitter is shaped to modify a shape of a beam of collected light that passes through the beam splitter.

According to a fourth aspect of the invention there is provided an optical module for steering a laser beam onto the material in an additive manufacturing apparatus, in which an object is built by consolidating material in a layer-by-layer manner using an energy beam, the optical module comprising an aperture from which the laser beam is delivered to the material and through which light generated by an interaction of the laser beam with the material is collected, a beam splitter angled relative to an optical path shared by the laser beam and the collected light, the beam splitter arranged to reflect the laser beam and transmit the collected light, wherein a rear surface of the beam splitter is shaped to modify a shape of a beam of collected light that passes through the beam splitter.

### DESCRIPTION OF THE DRAWINGS

FIG. 1 is a schematic representation of a selective laser melting (SLM) apparatus according to the invention;

FIG. 2 is a schematic representation of one embodiment of an optical unit according to the invention;

FIG. 3 is a graph showing the desired reflectivity profile of the mirrors;

FIG. 4 is a schematic representation of another embodiment of an optical unit according to the invention;

FIG. 5 is a schematic representation of a further embodiment of an optical unit according to the invention; and

FIG. 6 is a schematic representation of a yet another embodiment of an optical unit according to the invention.

### DESCRIPTION OF EMBODIMENTS

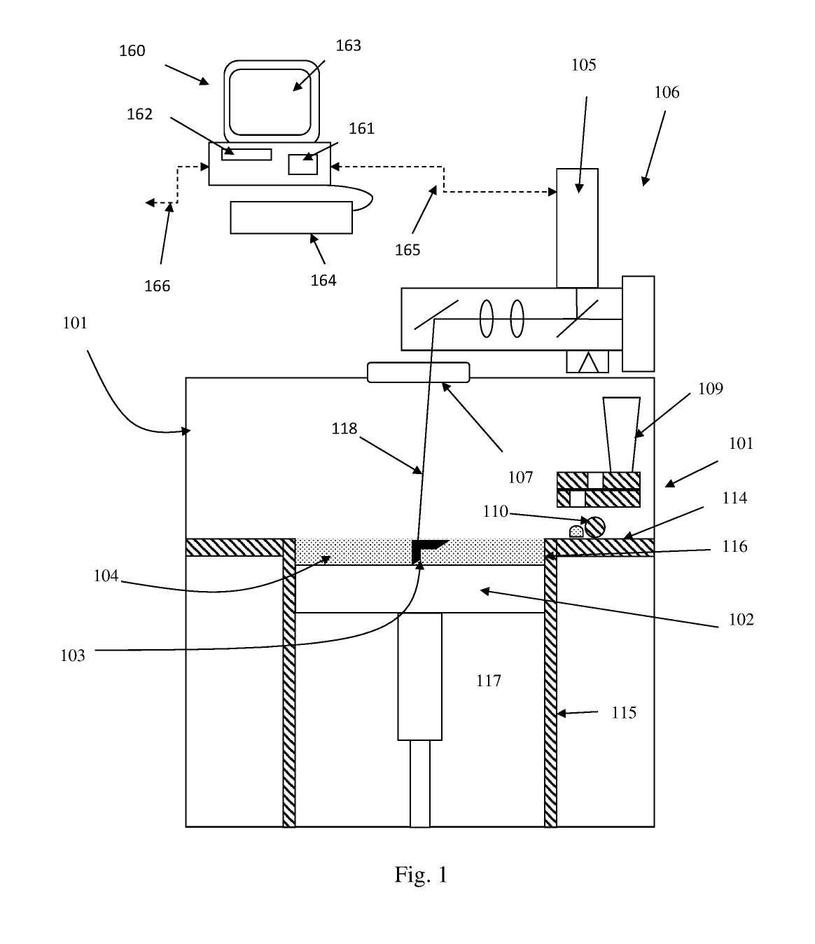

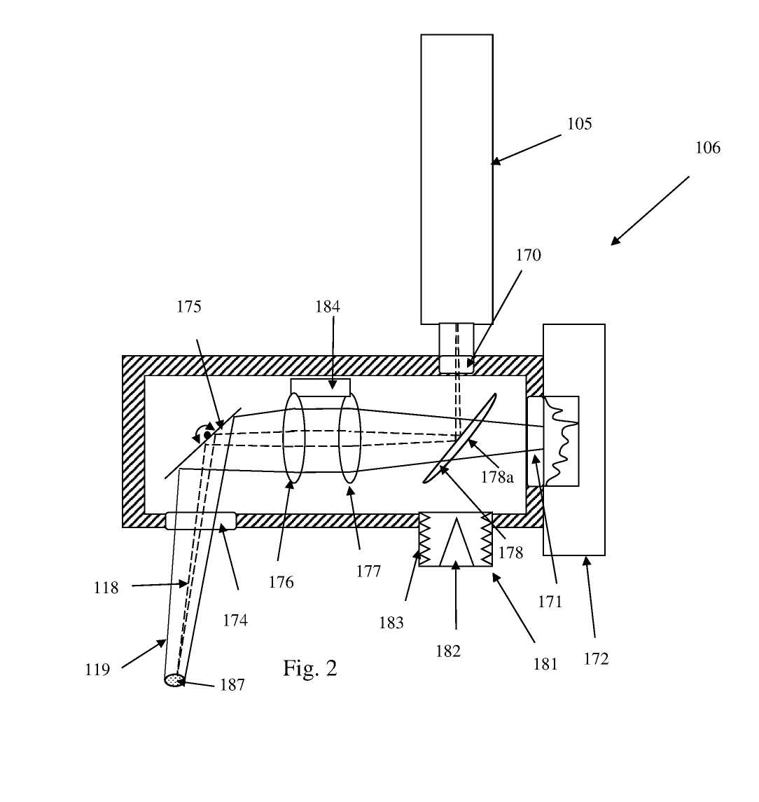

Referring to FIGS. 1 and 2, a selective laser melting (SLM) apparatus according to an embodiment of the invention comprises a build chamber 101 having therein partitions 114, 115 that define a build volume 116 and a surface onto which powder can be deposited. A build platform 102 defines a working area in which an object 103 is built by selective laser melting powder 104. The platform 102 can be lowered within the build volume 116 using mechanism 117 as successive layers of the object 103 are formed. A build volume available is defined by the extent to which the build platform 102 can be lowered into the build volume 116. Layers of powder 104 are formed as the object 103 is built by dispensing apparatus 109 and a wiper 110. For example, the dispensing apparatus 109 may be apparatus as described in WO2010/007396. A laser module 105 generates a laser for melting the powder 104, the laser directed onto the powder bed 104 as required by optical module 106 under the control of a computer 160. The laser beam 118 enters the chamber 101 via a window 107.

Computer 160 comprises a processor unit 161, memory 162, display 163, user input device 164, such as a keyboard, touch screen, etc, a data connection to modules of the laser melting apparatus, such as optical module 106, laser module 105 and motors (not shown) that drive movement of the dispensing apparatus, wiper and build platform 102. An external data connection 166 provides for the uploading of scanning instructions to the computer 160. The laser module 105, optical module 106 and movement of build platform 102 are controlled by the computer 160 based upon the scanning instructions.

FIG. 2 shows the optical module 106 in detail. The optical module comprises a laser aperture 170 for coupling to the laser module 105, a measurement aperture 171 for coupling to measurement devices 172 and output aperture 174 through which the laser beam is directed through window 107 on to the powder bed 104 and radiation emitted from the powder bed is collected.

The laser beam is steering and focussed to the required location on the powder bed 104 by scanning optics comprising two tiltable mirrors 175 (only one of which is shown) and movable focussing lenses 176, 177.

The tiltable mirrors 175 are each mounted for rotation about an axis under the control of an actuator, such as galvanometer. The axes about which the mirrors 175 are rotated are substantially perpendicular such that one mirror can deflect the laser beam in one direction (X-direction) and the other mirror can deflect the laser beam in a perpendicular direction (Y-direction). However, it will be understood that other arrangements could be used, such as a single mirror rotatable about two axes and/or the laser beam could be coupled, for example via an optical fibre, into a mirror mounted for linear movement in the X- and Y-directions. Examples of this latter arrangement are disclosed in US2004/0094728 and US2013/0112672.

In order to ensure that a focus of the laser beam is maintained in the same plane for changes in a deflection angle of the laser beam it is known to provide an f-O lens after tiltable mirrors. However, in this embodiment, the pair of movable lenses 176, 177 provided before (relative to the direction of travel of the laser beam) the tiltable mirrors 175 maintain the focus of the laser beam at the plane of the powder bed 104 as the deflection angle changes. Movement of the focussing lenses 176, 177 is controlled synchronously with movement of the tiltable mirrors 175. The focussing lenses 176, 177 may be movable towards and away from each other in a linear direction by an actuator, such as a voice coil 184.

The tiltable mirrors 175 and focussing lenses 176, 177 are selected appropriately to transmit both the laser wavelength, which is typically 1064 nm, and wavelengths of collected radiation 119 emitted from the melt pool 187.

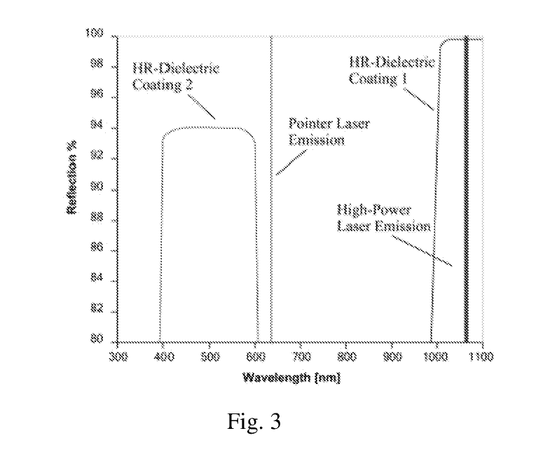

The mirrors 175 comprise a silver coating and the lenses 176, 177 are fused silica. In another embodiment, the mirrors 175 comprise a multi-layer dielectric coating that reflects the laser wavelength with a reflectivity of greater than 99% and preferably, greater than 99.5%, and wavelengths of the collected radiation 119, typically, wavelengths between 400 and 600 nm, with a reflectivity of greater than 80% for angles of incidence of between 30 to 60 degrees. FIG. 3 shows a typical reflectivity profile for the mirrors for these angles of incidence. As can be seen an alignment (pointing) laser used for aligning the main laser beam has a wavelength for which the mirrors are less than 80% reflective. The coatings may be SiO₂, TiO₂, Al₂O₃, Ta₂O₅ or fluorides such as MgF₂, LaF₃ and AlF₃.

A beam splitter 178 is provided between the focussing lenses 176, 177 and the laser 105 and measuring device 172. The beam splitter 178 is a notch filter that reflects light of the laser wavelength but allows wavelengths of the collected light 119 to pass therethrough. Laser light is reflected towards the focussing lenses 176, 177 and light that is collected by the scanning optics that is not of the laser wavelength is transmitted to measuring aperture 171. Reflection of the laser light 118 is preferred over transmission because of the potential for astigmatic artefacts to be introduced into the laser beam 118 from transmission through the beam splitter 178. The beam splitter 178 is selected to have a sufficiently low absorption for the laser wavelength, such as less than 1% and preferably less than 0.1% of the laser intensity. For a 200 Watt laser such a low absorption may maintain heating of the beam splitter 178 to less than a set temperature above ambient temperature, such as less than 6° C. above ambient. The notch filter is capable of reflecting all polarisations of light, i.e. both s- and p-polarised light, as the laser light is not polarised.

A rear surface 178a of the beam splitter 178 is shaped to form a corrective optical element for correcting for at least one optical aberration introduced into the collected light 119 by the beam splitter 178 and/or focussing lenses 176, 177. The optical aberrations may comprise spherical aberrations introduced into the collected light 119 by the focussing lenses and/or coma and astigmatism introduced into the collected light 119 as result of the converging collected light 119 (produced by the focussing lenses 176,177) impinging on the angled beam splitter 178.

The rear surface 178a may be shaped to form the corrective optical element using a laser ablation, melting and reflow process. In particular, a gross optical shape may first be formed on the rear surface 178a of the beam splitter 178 using laser ablation and subsequently a laser melting and reflow process is used to smooth the gross shape. This results in a rear surface 178a of the beam splitter with a shaped surface with low surface roughness, resulting in low scatter, and therefore, high efficiency.

In this embodiment, the rear surface 178a forms a refractive optical element that bends light transmitted through the beam splitter 178 differentially across a plane of the beam splitter 178 to compensate for aberrations, such as spherical aberrations, coma and astigmatism introduced into the collected light 119 by optical elements 176, 177, and the front portions of the beam splitter 178 through which the collected light 119 passes before passing through the rear surface 178a of the beam splitter 178. The refractive optical element may be a phase screen, in particular a continuous phase screen, formed across the rear surface 178a of the beam splitter 178. The form of the continuous phase screen may be determined using the algorithm disclosed in Dixit et al, “Designing fully continuous phase screens for tailoring focal-plane irradiance profiles”, Optics Letters, 1 Nov. 1996, Vol. 21, No 21, pages 1715 to 1717. The desired far field correction can be determined through theoretical analysis of the aberrations that would be introduced by the optical system.

In another embodiment, the rear surface 178a of the beam splitter 178 is shaped to form a diffractive optical element for correcting for the aberrations. A refractive optical element may be preferable over a diffractive optical element as diffractive optical elements may have comparable limited efficiency, zeroth order leakage, requiring off-axis operation of the detector, and strong wavelength dependence.

The optical module 106 further comprises a heat dump 181 for capturing laser light that is transmitted through the beam splitter 178. The majority of the laser light is, as intended, reflected by the beam splitter 178. However, a very small proportion of the laser light passes through the beam splitter 178 and this small proportion of laser light is captured by the heat dump 181. In this embodiment, the heat dump 181 comprises a central cone 182 that reflects light onto a scattering surface 183 located on the walls of the heat dump 181. The scattering surface 183 may be a surface having a corrugated or ridged surface that disperses the laser light. For example, the scattering surface 183 may comprise a ridge having a helix or spiral shape. The scattering surface may be made from anodised aluminium.

Various measuring devices can be connected to the measuring aperture 171. In this embodiment, a camera 172 is provided for imaging collected light 119. However, it will be understood that other detectors may be used, such as a spectrometer and/or one or more photodiodes arranged for detecting light within a narrow band of wavelengths may be provided. Preferably, the detector, such as camera 172, is for capturing an image from the collected light across a broad range of wavelengths, for example, a silicon based detector, which can detect light of between 300-1000 nm, and/or an InGaAs based detector, which can detect light of between 1000 nm to 3000 nm. The correction of the aberrations introduced by the beam splitter 178 reduces or eliminates blurring in a broadband image captured by such detectors.

In use, the computer 160 controls the laser 105 and the optical module 106 to scan the laser beam across areas of the powder layer to solidify selected areas based upon geometric data stored on the computer 160. Melting of the powder layer stimulates the material to generate thermal radiation. Some of the material will also be vaporised to form plasma. The plasma also emits radiation having a characteristic spectrum based on the materials present. Both radiation generated by the melt pool 187 and by the plasma is collected by the optical module 106 and directed towards the measuring device(s) 172.

The data recorded by the measuring device(s) is sent to computer 160, where the data is stored. Such data may then be used for later validation of the object built using the process. The data may also be analysed by the computer 160 in real-time (i.e. during the build) and, based on the analysis, the computer 160 may change parameters of the build.

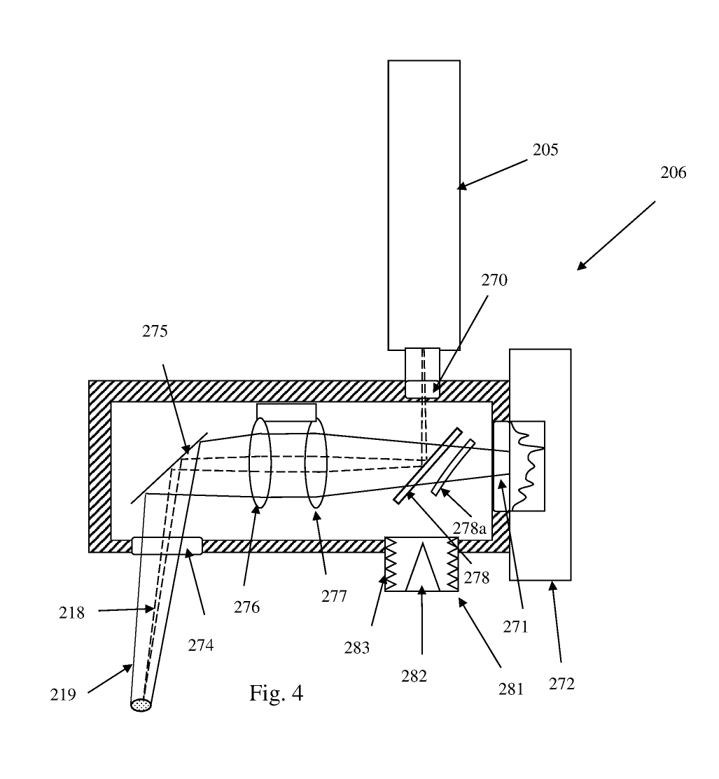

Referring to FIG. 4, another optical module is shown. Like numerals but in the series 200 are used to describe features of this embodiment that correspond to features of the embodiment described with reference to FIG. 2. Features of this embodiment that are substantially the same as the above described embodiment will not be described again and, for a description of these features, reference is made to the above description made with reference to FIGS. 2 and 3.

In this embodiment, rather than modifying a rear surface of the beam splitter 178 to correct for aberrations introduced into the collected light 219, a separate corrective optical element 278a is provided in the path of the collected light 219 transmitted through the beam splitter 278. The corrective optical element 278a comprises a curved lens having front and rear surfaces bent towards the transmitted image. The corrective optical element 278a may be as described in U.S. Pat. No. 4,412,723.

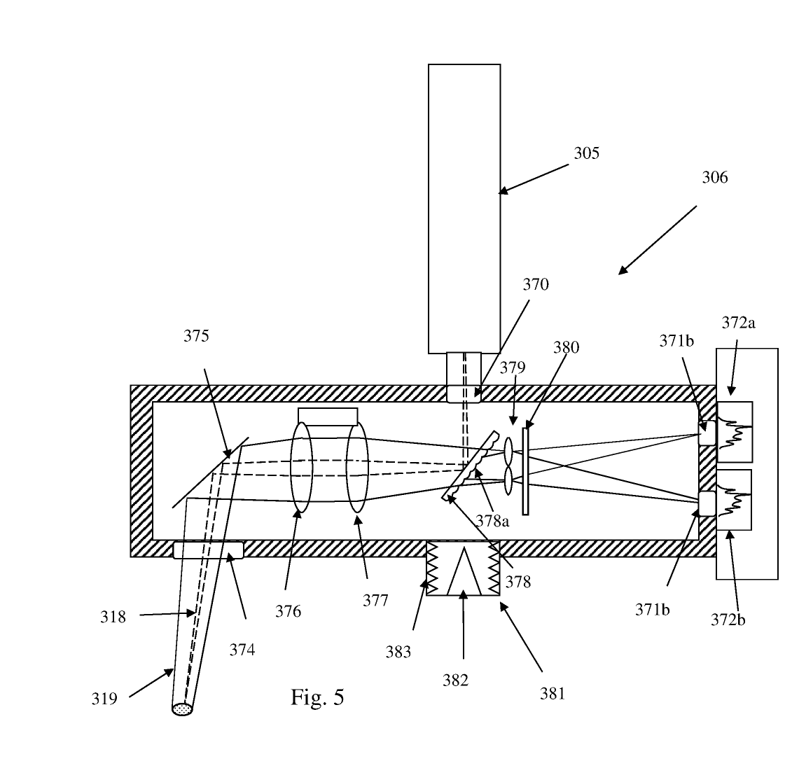

Referring to FIG. 5, in a further embodiment of an optical module according to the invention is shown. Like numerals but in the series 300 are used to describe features of this embodiment that correspond to features of the embodiments described with reference to FIGS. 2 and 4. Features of this embodiment that are substantially the same as the above described embodiments will not be described again and, for a description of these features, reference is made to the above description made with reference to FIGS. 2 to 4.

This embodiment differs from the embodiment described with reference to FIG. 2, in that a rear surface 378a of the beam splitter 378 is formed to provide one part of a two element homogenizer (comprising rear surface 378a and a second optical element 379) for dividing the collected light 319 into patches, wherein the near field is imaged into the far field for each patch. A Fourier lens 380 couples each patch into a corresponding outputs 371a, 371b, for delivering each patch to a different measuring device 372a, 372b. The rear surface 378a of the beam splitter 378 and the second optical element 379 may be formed as a fly's eye lens array for dividing the collected light 319 into the patches.

Such a device provides a compact method of splitting an image of the collected light for analysis using different measuring devices, without the need to align additional optical elements, such as additional beam splitters. Such a function may be used in conjunction with or separate form correction of the aberrations introduced into the collected light 319 by the optical elements 376, 377, and the front portions of the beam splitter 378.

In a further embodiment, the rear surface of the beam splitter is formed to spectrally disperse the collected light onto the detector.

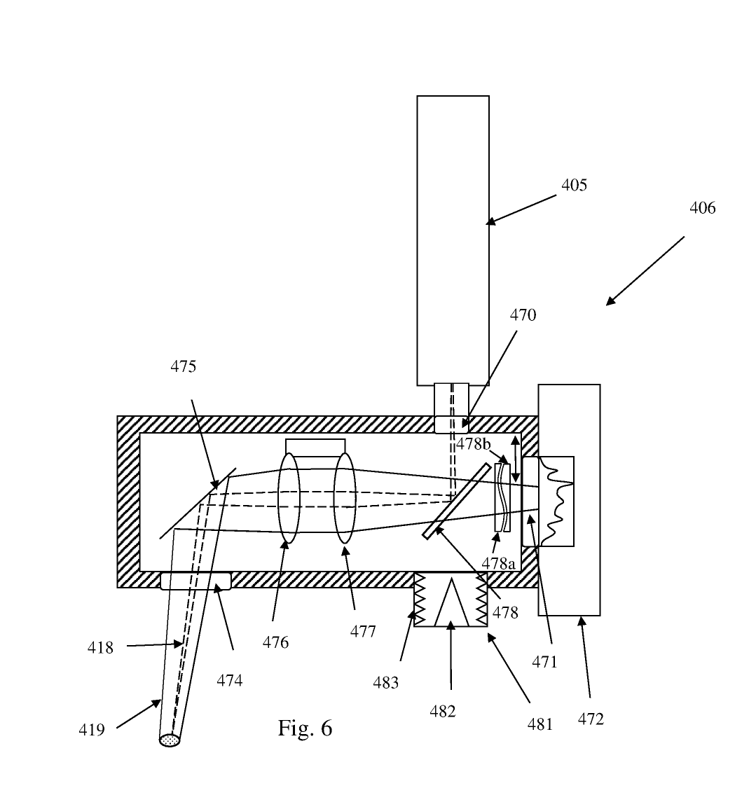

Referring to FIG. 6, in a further embodiment of an optical module according to the invention is shown. Like numerals but in the series 400 are used to describe features of this embodiment that correspond to features of the embodiments described with reference to FIGS. 2, 4 and 5. Features of this embodiment that are substantially the same as the above described embodiments will not be described again and, for a description of these features, reference is made to the above description made with reference to FIGS. 2, 4 and 5.

The embodiment of FIG. 6 differs from the above described embodiments in that an Alvarez lens 478a, 478b is used to correct for aberrations introduced into the collected light by the beam splitter 478. The Alvarez lens contains two transmissive refractive plates 478a, 478b, each having a plano surface and a surface shaped in a two-dimensional cubic profile. The two cubic surfaces are made to be the inverse of each other, so that when both plates are placed with their vertices on the optical axis, the induced phase variations cancel out. If the two plates are laterally displaced from this position, a phase variation is induced that is the differential of the cubic surface profiles, resulting in a quadratic phase profile. This quadratic phase profile can be used to correct for quadratic phase errors introduced in the collected light by the beam splitter 478. Accordingly, in use, the optical module would be setup to locate the two plates 478a, 478b relative to each other to correct for quadratic phase errors introduced in the collected light by the beam splitter 478.

1. An additive manufacturing apparatus for building an object by consolidating material in a layer-by-layer manner using an energy beam, the additive manufacturing apparatus comprising an optical module for steering a laser beam onto the material and for collecting light generated by an interaction of the laser beam with the material, the optical module comprising a beam splitter angled relative to an optical path shared by the laser beam and the collected light, the beam splitter separating the collected light from a path of the laser beam for directing the collected light to a detector, the optical module comprising a corrective optical element for correcting for at least one optical aberration introduced into the collected light by the beam splitter.

2. An additive manufacturing apparatus according to claim 1, wherein the laser beam is the energy beam used to consolidate the material.

3. An additive manufacturing apparatus according to claim 1, wherein the corrective optical element is an optical element separate from the beam splitter disposed in a path of the collected light downstream of the beam splitter.

4. An additive manufacturing apparatus according to claim 1, wherein the beam splitter is arranged for reflecting the laser wavelength and transmitting wavelengths of the collected light other than the laser wavelength, the corrective optical element formed as an optical feature in a rear surface of the beam splitter so as to modify collected light transmitted through the beam splitter.

5. An additive manufacturing apparatus according to claim 4, wherein the corrective optical element has been formed on the rear surface of the beam splitter by laser ablation.

6. An additive manufacturing apparatus according to claim 1, wherein the corrective optical element is a refractive optical element that bends light transmitted through the beam splitter differentially across a plane of the beam splitter to compensate for the aberrations.

7. An additive manufacturing apparatus according to claim 1, wherein the corrective optical element is an Alvarez lens.

8. An additive manufacturing apparatus according to claim 1, wherein the corrective optical element is a diffractive optical element.

9. An additive manufacturing apparatus according to claim 1, wherein the corrective optical element provides beam shaping in addition to correction of the aberrations.

10. An additive manufacturing apparatus according to claim 9, wherein the corrective optical element spatially offsets different wavelengths of the collected light and/or shapes the beam of collected light to effectively couple into the detector.

11. An additive manufacturing apparatus according to claim 1, wherein the optical module comprises focussing optics for focusing the laser beam on to the material, the collected light focussed into a non-collimated beam by the focussing optics before impinging on the beam splitter, wherein the corrective optical element corrects for aberrations arising as a result of the non-collimated beam of collected light impinging on the beam splitter.

12. An optical module for steering a laser beam onto the material in an additive manufacturing apparatus, in which an object is built by consolidating material in a layer-by-layer manner using an energy beam, the optical module comprising an aperture from which the laser beam is delivered to the material and through which light generated by an interaction of the laser beam with the material is collected, a beam splitter angled relative to an optical path shared by the laser beam and the collected light, the beam splitter separating the collected light from a path of the laser beam for directing the collected light to a detector, and a corrective optical element for correcting for at least one optical aberration introduced into the collected light by the beam splitter.

13. An additive manufacturing apparatus for building an object by consolidating material in a layer-by-layer manner using an energy beam, the additive manufacturing apparatus comprising an optical module for steering a laser beam onto the material and for collecting light generated by an interaction of the laser beam with the material, the optical module comprising a beam splitter angled relative to an optical path shared by the laser beam and the collected light, the beam splitter arranged to reflect the laser beam and transmit the collected light, wherein a rear surface of the beam splitter is shaped to modify a shape of a beam of collected light that passes through the beam splitter.

14. An optical module for steering a laser beam onto the material in an additive manufacturing apparatus, in which an object is built by consolidating material in a layer-by-layer manner using an energy beam, the optical module comprising an aperture from which the laser beam is delivered to the material and through which light generated by an interaction of the laser beam with the material is collected, a beam splitter angled relative to an optical path shared by the laser beam and the collected light, the beam splitter arranged to reflect the laser beam and transmit the collected light, wherein a rear surface of the beam splitter is shaped to modify a shape of a beam of collected light that passes through the beam splitter.
